(19) United States
(12) Patent Application Publication
(10) Pub. No.: US 2018/0130003 A1
(43) Pub. Date: May 10, 2018

(54) SYSTEMS AND METHODS TO PROVIDE A KPI DASHBOARD AND ANSWER HIGH VALUE QUESTIONS

(71) Applicant: General Electric Company, Schenectady, NY (US)

(72) Inventors: Andre Sublett, Schenectady, NY (US); Shamez Rajan, Schenectady, NY (US); Dhamodhar Ramanathan, Schenectady, NY (US)

(21) Appl. No.: 15/811,297

(22) Filed: Nov. 13, 2017

Related U.S. Application Data
(63) Continuation of application No. 14/473,802, filed on Aug. 29, 2014, now abandoned.
(60) Provisional application No. 61/892,392, filed on Oct. 17, 2013.

(51) Int. Cl. G06Q 10/06; G06Q 50/22; G06Q 30/02

(52) U.S. Cl. CPC G06Q 10/06393; G06Q 50/22; G06Q 30/0201

(57) ABSTRACT

Systems, apparatus, and methods to analyze and visualize healthcare-related data are provided. An example method includes identifying, for one or more patients, a clinical quality measure including one or more criterion. The method includes comparing a plurality of data points for each of the patient(s) to the one or more criterion. The method includes determining whether each of the patient(s) passes or fails the clinical quality measure based on the comparison to the one or more criterion. The method includes identifying a pattern of the failure based on patient data points relating to the failure of the clinical quality measure for each of the patient(s) failing the clinical quality measure. The method includes providing an interactive visualization of the pattern of failure in conjunction with the patient data points and an aggregated indication of passage or failure of the patient(s) with respect to the clinical quality measure.

### RELATED APPLICATIONS

This application is related to and claims the benefit of priority of Non-Provisional application Ser. No. 14/473,802, entitled “SYSTEMS AND METHODS TO PROVIDE A KPI DASHBOARD AND ANSWER HIGH VALUE QUESTIONS”, filed on Aug. 29, 2014, which claims the benefit of priority to Provisional Application U.S. Application Ser. No. 61/892,392, entitled “SYSTEMS AND METHODS TO PROVIDE A KPI DASHBOARD AND ANSWER HIGH VALUE QUESTIONS”, filed Oct. 17, 2013, the content of each of which is herein incorporated by reference in its entirety and for all purposes.

### FEDERALLY SPONSORED RESEARCH OR DEVELOPMENT

[Not Applicable]

### MICROFICHE/COPYRIGHT REFERENCE

[Not Applicable]

### FIELD

The presently described technology generally relates to systems and methods to analyze and visualize healthcare-related data. More particularly, the presently described technology relates to analyzing healthcare-related data in comparison to one or more quality measures and helping to answer high value questions based on the analysis.

### BACKGROUND

Most healthcare enterprises and institutions perform data gathering and reporting manually. Many computerized systems house data and statistics that are accumulated but have to be extracted manually and analyzed after the fact. These approaches suffer from “rear-view mirror syndrome”—by the time the data is collected, analyzed, and ready for review, the institutional makeup in terms of resources, patient distribution, and assets has changed. Regulatory pressures on healthcare continue to increase. Similarly, scrutiny over patient care increases.

### BRIEF SUMMARY

Certain examples provide systems, apparatus, and methods for analysis and visualization of healthcare-related data.

Certain examples provide a computer-implemented method including identifying, for one or more patients, a clinical quality measure including one or more criterion. The example method includes comparing, using a processor, a plurality of data points for each of the one or more patients to the one or more criterion defining the clinical quality measure. The example method includes determining, using the processor, whether each of the one or more patients passes or fails the clinical quality measure based on the comparison to the one or more criterion. The example method includes identifying, using the processor, a pattern of the failure based on patient data points relating to the failure of the clinical quality measure for each of the one or more patients failing the clinical quality measure. The example method includes providing, using the processor and via a graphical user interface, an interactive visualization of the pattern of failure in conjunction with the patient data points and an aggregated indication of passage or failure of the one or more patients with respect to the clinical quality measure.

Certain examples provide a tangible computer-readable storage medium including instructions which, when executed by a processor, cause the processor to provide a method. The example method includes identifying, for one or more patients, a clinical quality measure including one or more criterion. The example method includes comparing a plurality of data points for each of the one or more patients to the one or more criterion defining the clinical quality measure. The example method includes determining whether each of the one or more patients passes or fails the clinical quality measure based on the comparison to the one or more criterion. The example method includes identifying a pattern of the failure based on patient data points relating to the failure of the clinical quality measure for each of the one or more patients failing the clinical quality measure. The example method includes providing, via a graphical user interface, an interactive visualization of the pattern of failure in conjunction with the patient data points and an aggregated indication of passage or failure of the one or more patients with respect to the clinical quality measure.

Certain examples provide a system. The example system includes a processor configured to execute instructions to implement a visual analytics dashboard. The example visual analytics dashboard includes an interactive visualization of a pattern of failure with respect to a clinical quality measure by one or more patients, the clinical quality measure including one or more criterion, the interactive visualization display the pattern of failure in conjunction with the patient data points and an aggregated indication of passage or failure of the one or more patients with respect to the clinical quality measure. In the example system, the pattern of failure is determined by comparing, using the processor, a plurality of data points for each of the one or more patients to the one or more criterion defining the clinical quality measure; determining, using the processor, whether each of the one or more patients passes or fails the clinical quality measure based on the comparison to the one or more criterion; and identifying, using the processor, the pattern of the failure based on patient data points relating to the failure of the clinical quality measure for each of the one or more patients failing the clinical quality measure.

### BRIEF DESCRIPTION OF SEVERAL VIEWS OF THE DRAWINGS

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

FIG. 1 illustrates an example healthcare analytics system including a dashboard interacting with a database to provide visualization of data and associated analytics to a user.

FIG. 2 illustrates an example dashboard layer architecture.

FIG. 3 illustrates another view of an example healthcare analytics framework.

FIG. 4 illustrates an example real-time analytics dashboard system.

FIG. 5, including FIGS. 5A-5B, illustrates an example healthcare analytics framework providing a foundation to drive a visual analytics dashboard to provide insight into compliance with one or more measures at a healthcare entity.

FIG. 6 illustrates a flow diagram of an example method for measure data aggregation logic.

FIG. 7 illustrates relationships between numerator, denominator, and denominator exceptions with respect to an initial patient population.

FIG. 8 illustrates an example measure processing engine.

FIG. 9 illustrates a flow diagram of an example method to calculate measures using the example measure calculator.

FIG. 10 illustrates a flow diagram for an example method for clinical quality reporting.

FIG. 11, including FIGS. 11A-11B, provides an example of data ingestion services in a clinical quality reporting system.

FIG. 12, including FIGS. 12A-12B, provides an example of message processing services in a clinical quality reporting system.

FIG. 13 depicts an example visual analytics dashboard user interface providing quality reporting and associated analytics to a clinical user.

FIG. 14 illustrates another example dashboard interface providing analytics and quality reporting.

FIG. 15 illustrates another example analytic measures dashboard in which, for a particular measure, additional detail is displayed to the user such as a stratum for the measure.

FIG. 16 is a block diagram of an example processor system that may be used to implement the systems, apparatus and methods described herein.

### DETAILED DESCRIPTION OF CERTAIN EXAMPLES

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe an exemplary implementation and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible computer-readable storage medium such as a memory, DVD, CD, Blu-ray, etc. storing the software and/or firmware.

Healthcare has recently seen an increase in a number of information systems deployed. Due to departmental differences, growth paths and adoption of systems have not always been aligned. Departments use departmental systems that are specific to their workflows. Increasingly, enterprise systems are being installed to address some cross-department challenges. Much expensive integration work is required to tie these systems together, and, typically, this integration is kept to a minimum to keep down costs and departments instead rely on human intervention to bridge any gaps.

For example, a hospital may have an enterprise scheduling system to schedule exams for all departments within the hospital. This is a benefit to the enterprise and to patients. However, the scheduling system may not be integrated with every departmental system due to a variety of reasons. Since most departments use their departmental information systems to manage orders and workflow, the department staff has to look at the scheduling system application to know what exams are scheduled to be performed and potentially recreate these exams in their departmental system for further processing.

Certain examples help streamline a patient scanning process in radiology or other department by providing transparency to workflow occurring in disparate systems. Current patient scanning workflow in radiology is managed using paper requisitions printed from a radiology information system (RIS) or manually tracked on dry erase whiteboards. Given the disparate systems used to track patient prep, lab results, oral contrast, it is difficult for technologists to be efficient, as they need to poll the different systems to check status of patient. Further this information is not easily communicated as it is tracked manually. So any other individual would need to look up this information again or check information via a phone call.

Certain examples provide an electronic interface to display information corresponding to an event in a clinical workflow, such as a patient scanning and image interpretation workflow. The interface and associated analytics helps provide visibility into completion of workflow elements with respect to one or more systems and associated activity, tasks, etc.

Workflow definition can vary from institution to institution. Some institutions track nursing preparation time, radiologist in room time, etc. These states (events) can be dynamically added to a decision support system based on a customer's needs, wants, and/or preferences to enable measurement of key performance indicator(s) (KPI) and display of information associated with KPIs.

Certain examples provide a plurality of workflow state definitions. Certain examples provide an ability to store a number of occurrences of each workflow state and to track workflow steps. Certain examples provide an ability to modify a sequence of workflow to be specific to a particular site workflow. Certain examples provide an ability to cross reference patient visit events with exam events.

Current dashboard solutions are typically based on data in a RIS or picture archiving and communication system (PACS). Certain examples provide an ability to aggregate data from a plurality of sources including RIS, PACS, modality, virtual radiography (VR), scheduling, lab, pharmacy systems, etc. A flexible workflow definition enables example systems and methods to be customized to a customer workflow configuration with relative ease.

Certain examples help provide an understanding of the real-time operational effectiveness of an enterprise and help enable an operator to address deficiencies. Certain examples thus provide an ability to collect, analyze and review operational data from a healthcare enterprise in real time or substantially in real time given inherent processing, storage, and/or transmission delay. The data is provided in a digestible manner adjusted for factors that may artificially affect the value of the operational data (e.g., patient wait time) so that an appropriate responsive action may be taken.

KPIs are used by hospitals and other healthcare enterprises to measure operational performance and evaluate a patient experience. KPIs can help healthcare institutions, clinicians, and staff provide better patient care, improve department and enterprise efficiencies, and reduce the overall cost of delivery. Compiling information into KPIs can be time consuming and involve administrators and/or clinical analysts generating individual reports on disparate information systems and manually aggregating this data into meaningful information.

KPIs represent performance metrics that can be standard for an industry or business but also can include metrics that are specific to an institution or location. These metrics are used and presented to users to measure and demonstrate performance of departments, systems, and/or individuals. KPIs include, but are not limited to, patient wait times (PWT), turn around time (TAT) on a report or dictation, stroke report turn around time (S-RTAT), or overall film usage in a radiology department. For dictation, a time can be a measure of time from completed to dictated, time from dictated to transcribed, and/or time from transcribed to signed, for example.

In certain examples, data is aggregated from disparate information systems within a hospital or department environment. A KPI can be created from the aggregated data and presented to a user on a Web-enabled device or other information portal/interface. In addition, alerts and/or early warnings can be provided based on the data so that personnel can take action before patient experience issues worsen.

For example, KPIs can be highlighted and associated with actions in response to various conditions, such as, but not limited to, long patient wait times, a modality that is underutilized, a report for stroke, a performance metric that is not meeting hospital guidelines, or a referring physician that is continuously requesting films when exams are available electronically through a hospital portal. Performance indicators addressing specific areas of performance can be acted upon in real time (or substantially real time accounting for processing, storage/retrieval, and/or transmission delay), for example.

In certain examples, data is collected and analyzed to be presented in a graphical dashboard including visual indicators representing KPIs, underlying data, and/or associated functions for a user. Information can be provided to help enable a user to become proactive rather than reactive. Additionally, information can be processed to provide more accurate indicators accounting for factors and delays beyond the control of the patient, the clinician, and/or the clinical enterprise. In some examples, “inherent” delays can be highlighted as separate actionable items apart from an associated operational metric, such as patient wait time.

Certain examples provide configurable KPI (e.g., operational metric) computations in a work flow of a healthcare enterprise. The computations allow KPI consumers to select a set of relevant qualifiers to determine a scope of a data countable in the operational metrics. An algorithm supports the KPI computations in complex work flow scenarios including various work flow exceptions and repetitions in an ascending or descending work flow statuses change order (such as, exam or patient visit cancellations, re-scheduling, etc.), as well as in scenarios of multi-day and multi-order patient visits, for example.

Thus, certain examples help facilitate operational data-driven decision-making and process improvements. To help improve operational productivity, tools are provided to measure and display a real-time (or substantially real-time) view of day-to-day operations. In order to better manage an organization's long-term strategy, administrators are provided with simpler-to-use data analysis tools to identify areas for improvement and monitor the impact of change. For example, imaging departments are facing challenges around reimbursement. Certain examples provide tools to help improve departmental operations and streamline reimbursement documentation, support, and processing.

In certain examples, a KPI dashboard is provided to display KPI results as well as providing answers to “high-value questions” which the KPIs are intended to answer. For example, when applied to meaningful use, the example dashboard not only displays measure results but also directly answers the three key high value questions posed for meaningful use:

1. Have I met the government requirements for MU?

2. Which measures are not meeting the government target thresholds?

3. Who are the patients who that did not receive the government's target level of care?

When a patient is compared against a measure, the patient may pass or fail, but a user (e.g., a provider, hospital administrator, etc.) wants to know what particular patient data criterion is causing them to fail so that the user can bring the criterion/reason to the attention of a business analyst, clinician, etc., to help remedy the issue, problem, or deficiency, for example. A user can see what kind of patient data points are causing them to fail and can see patterns of failure that could inform how a clinical could better address the situation and improve the performance measure. Certain examples help provide insight and analytics around specific patient data criteria and reasons for failure to satisfy appropriate measure(s). Certain examples can drive access to the underlying data and/or patterns of data to help enable mitigation and/or other correction of failures and/or other troublesome results.

In certain examples, the KPI dashboard provides a summary area at the top of the dashboard that directly answers the top, primary, or “main” question the KPIs have been collected to answer. In the meaningful use example, that question is: “Has the selected provider met the government requirements for meaningful use?” The summary section of the dashboard displays a direct answer to that question—that is, whether the meaningful use requirements have been met or have not been met. A summary control also provides details around individual requirement(s) that must be met to answer the question. Without this section, that user would have to view the results of each measure and determine what requirement that measure and result have impacted and then determine if the aggregation of all measures they are tracking resulted in the overall requirements being met or not.

Additionally, the example dashboard answers a second high-value question that a user may want to determine from provided KPIs: which measure(s) are not meeting the government mandated thresholds. For example, the dashboard can visualize, for each measure, whether that measure has met the required threshold or has not met the required threshold.

Further, the example dashboard answers a third high-value question: which patients are not meeting the required level of care. For example, the interface can provide a KPI results ring including a segment related to “failed” KPI metrics. By selecting the failed KPI metrics portion (e.g., a red portion of the KPI results ring, etc.), a list of all patients who did not receive a target level of care can be displayed. A similar process can provide answers to other high value question such as which patients were exceptions to the KPI measurement, for example. Selecting (e.g., clicking on) a particular patient can allow a user to access and taken an action with respect to the selected patient.

A combination of these elements transforms the dashboard from one of simple information to a dashboard that utilizes knowledge and insight of a customer's high-value questions to directly answer the customer's needs/wants. For example, KPI-style dashboards typically provide data (the KPI results) but to not directly answer the high-value questions a customer is tracking the KPIs to answer. Certain examples provide a dashboard and associated system that go beyond providing information to present results in a manner that more directly answers the user questions. By presenting more direct and/or extensive answers to high-value questions, certain examples help prevent a user from having to study and interpret KPI results in an effort to manually answer their questions. Certain examples can also help prevent error that may occur through manual user interpretation of KPI data to determine answers to their questions.

Rather than providing individual reports for each measure (e.g., each meaningful use measure) that include data for each provider, KPI Dashboards can be created that provide the KPI data being tracked. A user can analyze the data and apply the data to question(s) they are trying to answer, for example.

Certain examples provide a system including: 1) a Healthcare Analytics Framework (HAF); 2) analytic content; and 3) integrated products. For example, the HAF provides an analytics infrastructure, services, visualizations, and data models that provide a basis to deliver analytic content. Analytic content can include content such as measures for or related to Meaningful Use (MU), Physician Quality Reporting System (PQRS), Bridge to Excellence (BTE), other quality program, etc. Integrated products can include products that serve data to the HAF, embed HAF visualizations into their applications, and/or integrate with HAF through various Web Service application program interfaces (APIs). Integrated products can include an electronic medical record (EMR), electronic health record (EHR), personal health record (PHR), enterprise archive (EA), picture archiving and communication system (PACS), radiology information system (RIS), cardiovascular information system (CVIS), laboratory information system (LIS), etc. In certain examples, analytics can be published via National Quality Forum (NQF) eMeasure specifications.

A HAF-based system can logically be broken down as follows: a visual analytic framework, an analytics services framework, an analytic data framework, HAF content, and HAF integration services. A visual analytic framework can include, for example, a dashboard, visual widgets, an analytics portal, etc. An analytics services framework can include, for example, a data ingestion service, a data reconciliation service, a data evidence service, data export services, an electronic measure publishing service, a rules engine, a statistical engine, a data access object (DAO) domain models, user registration, etc. An analytic data framework can include, for example, physical data models, a data access layer, etc. HAF content can include, for example, measure-based (e.g., MU, PQRS, etc.) analytics, an analytics (e.g., MU, PQRS, etc.) dashboard, etc. HAF Integration Services can include, for example, data extraction services, data transmission services, etc.

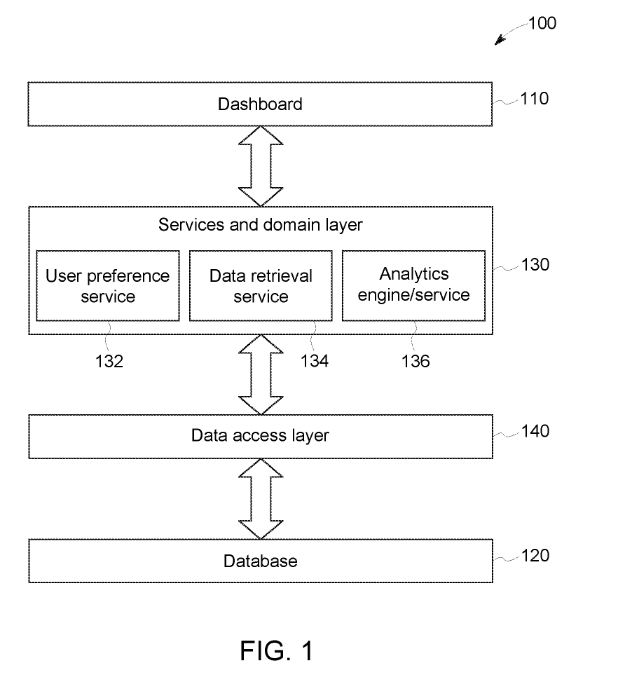

FIG. 1 illustrates an example healthcare analytics system 100 including a dashboard 110 interacting with a database 120 to provide visualization of data and associated analytics to a user. The dashboard 110 serves as a primary interface for interaction with the user at the end of a data processing pipeline. The dashboard 110 is responsible for displaying results of rules being applied to incoming source data in a format that helps the user understand the information being shown. The dashboard 110 aims to help users explore, analyze, identify and act upon key problem areas being shown in the data. In certain examples, analysis of data can be done within the dashboard 110, which is often integrated with a data source such as an EMR, EHR, PHR, EA, PACS, RIS, CVIS, LIS, and/or other database 120, from which the source data originates.

The dashboard 120 utilizes a services and domain layer 130 which includes services for set user preference 132, data retrieval 134, and analytics 136. Thad dashboard 110 issues data retrieval requests to the services and domain layer 130 on behalf of the user. The services 132, 134, 136 retrieves data from the database 120 via a data access layer 140 and then forwards the data back to the dashboard 110.

The data access layer 140 provides an abstraction to one or more data sources 120, and the way these data source(s) can be accessed from consumers of data access layer 140. The data access layer 140 acts as a provider service and provides simplified access to data stored in persistent storage such as relational and non-relational data store(s) 120. The data access layer 140 hides the complexity of handing various access operations on various underlying supported data stores 120 from data consumers, such as the services layer 130, dashboard 110, etc.

The dashboard 110 renders and displays the data based on user preferences. Additional analytics may also be performed on the data within the dashboard 110. In certain examples, the dashboard 110 is designed to be accessed via a web browser.

In certain examples, a national provider identifier (NPI) identifies a provider in the database 120. Based on the NPI, providers can be linked with patients (e.g., identified by a medical patient index (MPI)) to display measure results on the dashboard 110.

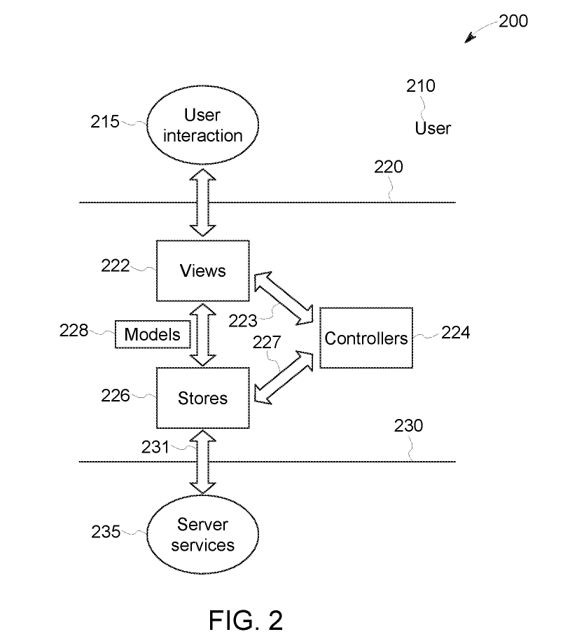

FIG. 2 illustrates an example dashboard layer architecture 200. The dashboard architecture 200 is event-driven and, therefore, allows more tolerance for unpredictable and asynchronous behavior, for example. As shown in the example of FIG. 2, a user 210 interacts with a dashboard layer 220 which communicates with a services layer 230. User interaction 215 occurs via one or more views 222 provided by the dashboard layer 220. Stores 226 are responsible for retrieving data 231 and storing data 231 as model instances 228. Models 228 act as data access objects, for example. In order to maintain data abstraction, certain examples provide different models for different types of data 231 coming in. Views 222 and stores 226 both generate events 223, 227 that are then manipulated by controllers 224. In certain examples, an observer pattern is employed based on an event-driven architecture such that events generated by each component are passed on to listeners, which take action for the dashboard 220. Each component within the dashboard 220 stands as an independent entity and may be placed anywhere in a dashboard layout. The dashboard application 220 acts as an independent application and is able to act independently of the services layer 230, for example.

In certain examples, a view 222 requests more data 231 from an associated store 226, due to user interaction 215 and/or due to controller 224 manipulation. The store 226 then contacts the services layer 235 via the web, for example. The store 226 receiving the data 231 parses the data 231 into instances of an associated model 228. The model instances 228 are then passed back to the view 222, which displays the model instances 228 to the user. Events 223, 227 are generated as a result of these actions, and controllers 224 listening for those events 223, 227 can take action at any point, for example.

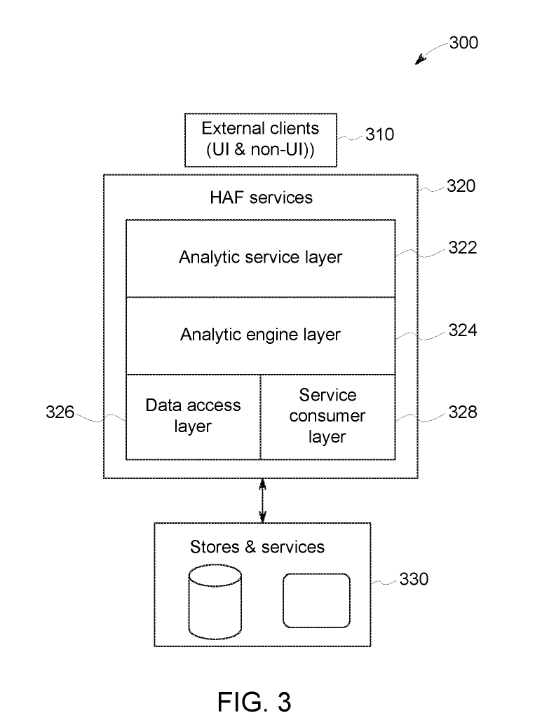

FIG. 3 illustrates another view of an example healthcare analytics framework 300. The example framework 300 includes one or more external clients 310 (e.g., user interface and/or non-user interface based), HAF services 320, and data stores and services 330. The HAF services 320 includes an analytics services layer 322, an analytics engine layer 324, a data access layer 326, and a service consumer layer 328. Using an external client 310 (e.g., a dashboard running via a web browser on a user's computing device), queries are sent to the HAF services 320 for data and associated analytics related to one or more selected measures (e.g., quality measures). Within the HAF services 320, the analytics services 322 receives the request from the client 310 and processes the request for the analytics engine 324. The analytics engine 324 uses the data access layer 326 and the service consumer layer 328 to query the data store(s)/service(s) 330 for the requested data. Once received and formatted by the data access layer 326 and service consumer layer 328, the analytics engine 324 analyzes the retrieved data according to one or more measures, preferences, parameters, criterion, etc. Data and/or associated analytics are then provided by the analytics service layer 322 to the client 310. Communication and/or other data exchange between client 310 and HAF services 320 can occur via one or more of Representational State Transfer (REST), Simple Object Access Protocol (SOAP), JavaScript Object Notation (JSON), Extensible Markup Language (XML), etc., for example.

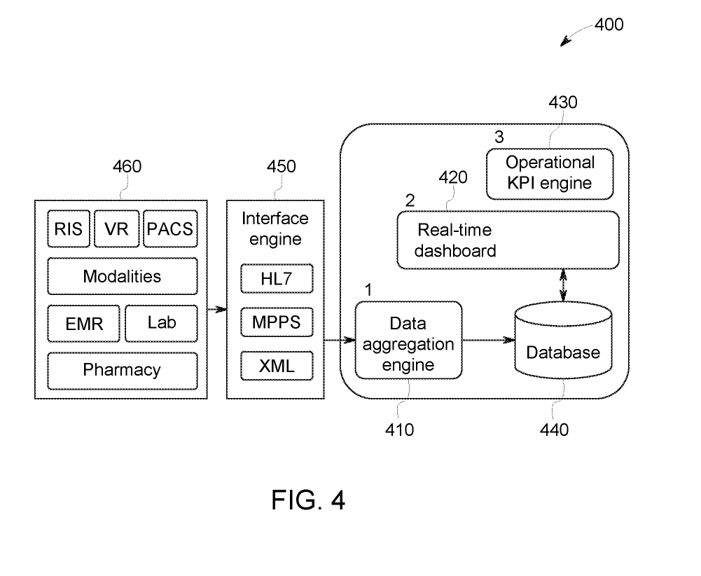

FIG. 4 illustrates an example real-time analytics dashboard system 400. The real-time analytics dashboard system 400 is designed to provide radiology and/or other healthcare departments with transparency to operational performance around workflow spanning from schedule (order) to report distribution.

The dashboard system 400 includes a data aggregation engine 410 that correlates events from disparate sources 460 via an interface engine 450. The system 400 also includes a real-time dashboard 420, such as a real-time dashboard web application accessible via a browser across a healthcare enterprise. The system 400 includes an operational KPI engine 430 to pro-actively manage imaging and/or other healthcare operations. Aggregated data can be stored in a database 440 for use by the real-time dashboard 420, for example.

The real-time dashboard system 400 is powered by the data aggregation engine 410, which correlates in real-time (or substantially in real time accounting for system delays) workflow events from PACS, RIS, EA, and other information sources, so users can view status of one or more patients within and outside of radiology and/or other healthcare department(s). Patient status can be compared against one or more measures, such as MU, PQRS, etc.

The data aggregation engine 410 has pre-built exam and patient events, and supports an ability to add custom events to map to site workflow. The engine 410 provides a user interface in the form of an inquiry view, for example, to query for audit event(s). The inquiry view supports queries using the following criteria within a specified time range: patient, exam, staff, event type(s), etc. The inquiry view can be used to look up audit information on an exam and visit events within a certain time range (e.g., six weeks). The inquiry view can be used to check a current workflow status of an exam. The inquiry view can be used to verify staff patient interaction audit compliance information by cross-referencing patient and staff information.

The interface engine 430 (e.g., a CCG interface engine) is used to interface with a variety of information sources 460 (e.g., RIS, PACS, VR, modalities, electronic medical record (EMR), lab, pharmacy, etc.) and the data aggregation engine 410. The interface engine 450 can interface based on HL7, DICOM, XML, MPPS, HTML5, and/or other message/data format, for example.

The real-time dashboard 420 supports a variety of capabilities (e.g., in a web-based format). The dashboard 420 can organize KPI by facility and/or other organization and allow a user to drill-down from an enterprise to an individual facility (e.g., a hospital) and the like. The dashboard 420 can display multiple KPI simultaneously (or substantially simultaneously), for example. The dashboard 420 provides an automated “slide show” to display a sequence of open KPI and their compliance or non-compliance with one or more selected measures. The dashboard 420 can be used to save open KPI, generate report(s), export data to a spreadsheet, etc.

The operational KPI engine 430 provides an ability to display visual alerts indicating bottleneck(s), pending task(s), measure pass/fail, etc. The KPI engine 430 computes process metrics using data from disparate sources (e.g., RIS, modality, PACS, VR, EMR, EA, etc.). The KPI engine 430 can accommodate and process multiple occurrences of an event and access detail data under an aggregate KPI metric, for example. The engine 430 can specify a user-defined filter and group by options. The engine 430 can accept customized KPI thresholds, time depth, etc., and can be used to build custom KPI to reflect a site workflow, for example.

The dashboard system 400 can provide graphical reports to visualize patterns and quickly identify short-term trends, for example. Reports are defined by, for example, process turnaround times, asset utilization, throughput, volume/mix, and/or delay reasons, etc. The dashboard system 400 can also provide exception outlier score cards, such as a tabular list grouped by facility for a number of exams exceeding turnaround time threshold(s). The dashboard system 400 can provide a unified list of pending emergency department (ED), outpatient, and/or inpatient exams in a particular modality (e.g., department) with an ability to: 1) display status of workflow events from different systems, 2) indicate pending multi-modality exams for a patient, 3) track time for a certain activity related to an exam via countdown timer, and/or 4) electronically record Delay Reasons, a Timestamp for the occurrence of a workflow event, for example.

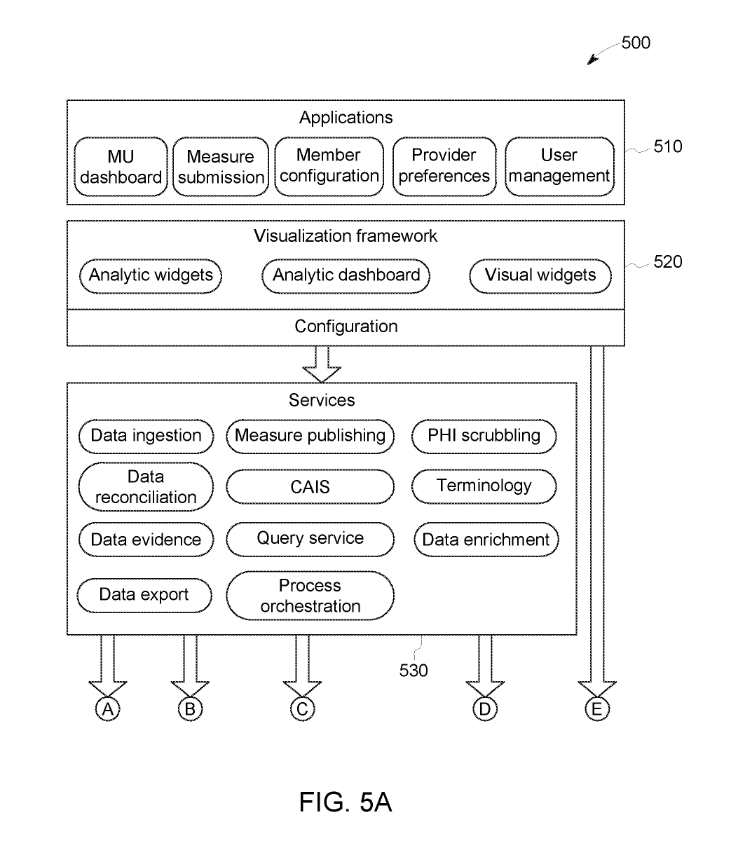

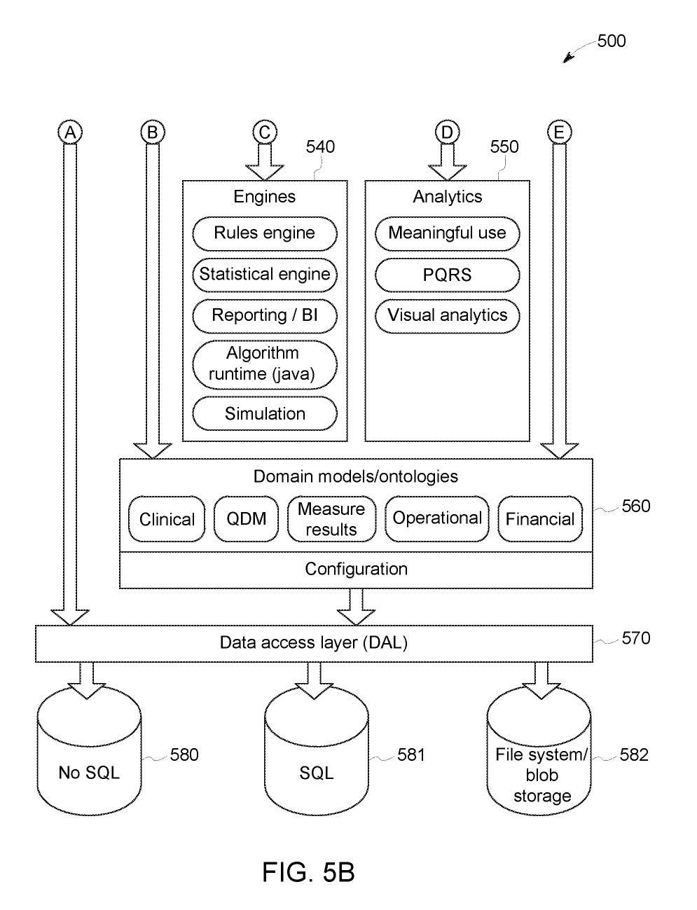

FIG. 5 illustrates an example healthcare analytics framework 500 providing a foundation to drive a visual analytics dashboard to provide insight into compliance with one or more measures at a healthcare entity. As shown in the example of FIG. 5, the example HAF 500 includes one or more applications 510 leveraging a visualization framework 520 which communicates with services 530 for access to and analysis of data from one or more data sources 580-583. The services 530 interact with an engine 540 and analytics 550 to retrieve and process data according to one or more domain models and/or ontologies 560 via a data access layer 570.

As shown in the example of FIG. 5, applications 510 can include a dashboard (e.g., a MU dashboard, PQRS dashboard, clinical quality reporting dashboard, and/or other dashboard), measure submission, member configuration, provider preferences, user management, etc. The visualization framework 520 can include an analytic dashboard and one or more analytic widgets, visual widgets, etc., for example. Services 530 can include data ingestion, data reconciliation, data evidence, data export, measure publishing, clinical analysis integration service (CAIS), query service, process orchestration, protected/personal health information (PHI), terminology, data enrichment, etc., for example. Engines 540 can include a rules engine, a statistical engine, reporting/business intelligence (BI), an algorithm runtime (e.g., Java), simulation, etc., for example. Analytics 550 can include meaningful use analytics, PQRS analytics, visual analytics, etc., for example.

As shown in the example of FIG. 5, domain models and/or ontologies 560 can include one or more of clinical, quality data model (QDM), measure results, operational, financial, etc., for example. The data access layer 570 communicates with one or more data sources including via structured query language (SQL) communication 581, non-SQL communication 582, file system/blob storage 583, etc., for example.

Certain examples provide an infrastructure to run and host a reporting system and associated analytics. For example, a user administrator is provided with a secure hosted environment that provides analytic capabilities for his or her business. User security can be facilitated through applied authentication and authorization to a user on log to access data and/or analytics (e.g., including associated reports).

Certain examples provide an administrator with configuration ability to configure an organizational structure, users, etc. For example, an organization's organizational structure is available within the system to be used for activities such as user management, filtering, aggregation, etc. In certain examples, an n-level hierarchy is supported. Using the HAF infrastructure, a business can identify users who can access the system and control what they can do and see by organizational hierarchy and role, for example. A user administrator can add user(s) to an appropriate level of their organizational structure and assign roles to those users, for example. Configured users are able to login and access features per their role and position in the organizational structure, for example.

Certain examples facilitate data ingestion into the system through bulk upload of member data (e.g., from EMR, EHR, EA, PACS, RIS, etc.). Additionally, new or updated data can be added to existing data, for example.

In certain examples, data analysis models can be provided (e.g., based on organization, based on QDM, based on particular measure(s), etc.) to create analytics against the model for the data, for example. Alternatively or in addition, measure results model(s) can be provided to drive visualization of the data and/or associated analytics. Models can be configured for one or more locations, for example. Resulting analytic(s) and/or rule(s) can be published (e.g., via an eMeasure electronic specification, etc.). Measures may be calculated for pre-defined reporting periods, for example.

In certain examples, a clinical manager can configure his or her organization and set measure threshold(s) for the organization. A provider can provide additional information about the practice. An administrator can define measures (e.g., MU stage one and/or stage two measures) to make available via the HAF, and a clinical manager can select measures to track in their HAF implementation and associated dashboard.

In certain examples, measures can be visualized via an analytics dashboard. For example, a provider views selected measures (e.g., MU, PQRS, other quality and/or performance measures) in a dashboard (e.g., a measure summary dashboard). The provider can export their (e.g., MU) dashboard as a document (e.g., a portable document format (PDF) document, comma-separated value (CSV) document, etc.). The document can be stored, published, routed to another user and/or application for further processing and/or analysis, etc.

Using the dashboard, a provider can view their performance trends, for example. The provider can further view additional information on any of their selected measures from the dashboard, for example. In certain examples, the provider can view a list of patients who make up a numerator, denominator, exclusions or exceptions for selected measures on the dashboard (e.g., the MU or PQRS dashboard).

In certain examples, a clinical manager can filter and/or aggregate data by organizational structure via the dashboard. A clinical manager and/or provider can filter by time period, for example, the data presented on the measure dashboard. In certain examples, a user can be provided with quality information via an embedded dashboard in a quality tab of another application.

Certain examples provide a set of hosted analytic services and applications that can answer high value business questions for registered users and provide a mechanism for collecting data that can be used for licensed third party clinical research. Certain examples can be provided via an analytics as a service (AaaS) offering with hosted services and applications focused on analytics. Services and application can be hosted within a data center, public cloud, etc. Access to hosted analytics can be restricted to authenticated registered users, for example, and user can use a supported Web browser to access hosted application(s).

Certain examples help to integrate systems utilize Web Services and healthcare standards to send data to an analytics cloud and access available services. Access to data, services, and applications within the analytic cloud can be restricted by organization structure and/or role, for example. In certain examples, access to specific services, applications and features are restricted to businesses that have purchased those products.

In certain examples, providers who have consented to do so will have their data shared with licensed third party researchers. Data shared with third parties will not contain PHI data and will be certified as statistically anonymous, for example.

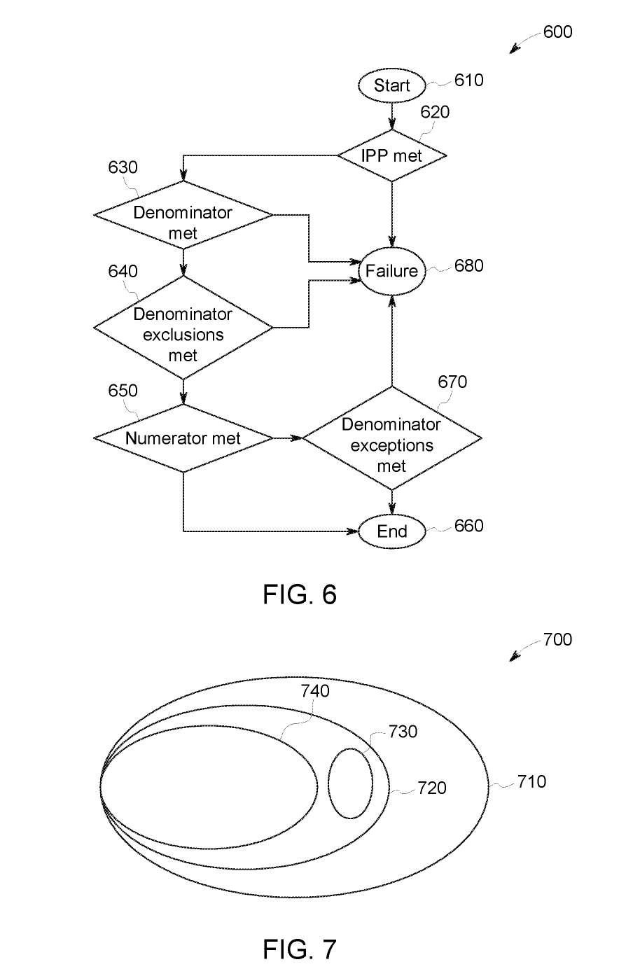

FIG. 6 illustrates a flow diagram of an example method 600 for measure data aggregation logic. As illustrated in the example of FIG. 6, a clinical quality measure (CQM) is a mechanism used to assess a degree to which a provider competently and safely delivers clinical services that are appropriate for a patient in an optimal or other desired or preferred timeframe. In certain examples, CQMs include four to five components: initial patient population (IPP), denominator, numerator, and exclusions and/or exceptions. IPP is defined as a group of patients that a performance measure (e.g., the CQM) is designed to address. For example, the IPP may be patient greater than or equal to eighteen years of age with an active diagnosis of hypertension who have been seen for at least two or more visits by their provider. The denominator is a subset of the initial patient population. For example, in some eMeasures, the denominator may be the same as the initial patient population. The numerator is a subset of the denominator for whom a process or outcome of care occurs. For example, the numerator may include patients who are greater than or equal to eighteen years of age with an active diagnosis of hypertension who have been seen for at least two or more visits by their provider (same as initial patient population) and have a recorded blood pressure.

In certain examples, denominator exclusions are used to exclude patients from the denominator of a performance measure when a therapy or service would not be appropriate in instances for which the patient otherwise meets the denominator criteria. In certain examples, denominator exceptions are an allowable reason for nonperformance of a quality measure for patients that meet the denominator criteria and do not meet the numerator criteria. Denominator exceptions are the valid reasons for patients who are included in the denominator population but for whom a process or outcome of care does not occur. Exceptions allow for clinical judgment and fall into three general categories: medical reasons, patients' reasons, and systems reasons.

As demonstrated in FIG. 6, for a given measure identified at 610, at block 620, data for a user entity (e.g., a physician, a hospital, a clinic, an enterprise, etc.) is evaluated to determine whether the IPP is met by that entity for the measure. If so, then, at block 630, data for the entity is evaluated to determine whether the denominator for the measure is met. If so, then, at block 640, the data is evaluated to see if any denominator exclusions are met. If not, then, at block 650, data for the entity is evaluated to determine whether the numerator for the measure is met. If so, then, at block 660, the evaluation ends successfully (e.g., the measure is met). If not, then, at block 670, denominator exceptions are evaluated to see if any exception is met. If so, then at block 660, the measure evaluation ends successfully. If at end point the condition is not met (with the reverse being true for the denominator exclusion test at block 640), then, at block 680, the evaluation ends in failure.

In certain examples, a measure percentage calculation can be determined as follows: Percentage=Numerator/(Denominator−DenominatorExclusion−DenominatorException). A results total can be calculated as follows: Results Total=Denominator−DenominatorExclusion−DenominatorException, for example.

In certain examples, denominator exclusions are factors supported by the clinical evidence that should remove a patient from inclusion in the measure population; otherwise, they are supported by evidence of sufficient frequency of occurrence so that results are distorted without the exclusion. Denominator exceptions are those conditions that should remove a patient, procedure or unit of measurement from the denominator only if the numerator criteria are not met. Denominator exceptions allow for adjustment of the calculated score for those providers with higher risk populations and allow for the exercise of clinical judgment. Generic denominator exception reasons used in proportion eMeasures fall into three general categories: medical reasons, patient reasons, and system reasons (e.g., a particular vaccine was withdrawn from the market). Denominator exceptions are used in proportion eMeasures. This measure component is not universally accepted by all measure developers.

As illustrated in FIG. 7, exclusions constitute the gap between the IPP and denominator ovals. Exceptions are those that do meet denominator but are allowed to be taken out of the calculation if the numerator is not met, with election and justification by the clinician. In certain examples, not all CQMs have exclusions or exceptions.

Certain examples provide a measure processing engine. The measure processing engine applies measures such as eMeasures, functional measures, and/or core measures, etc., set forth by the Centers for Medicare and Medicaid Services (CMS) and/or other entity on patient data expressed in QDM format. The measure processing engine produces measure processing results along with conjunction traceability. In certain examples, the measure processing engine is executed per the following combination of data points: measurement period, patient QDM data set, list of relevant measure(s), eligible provider (EP), for example.

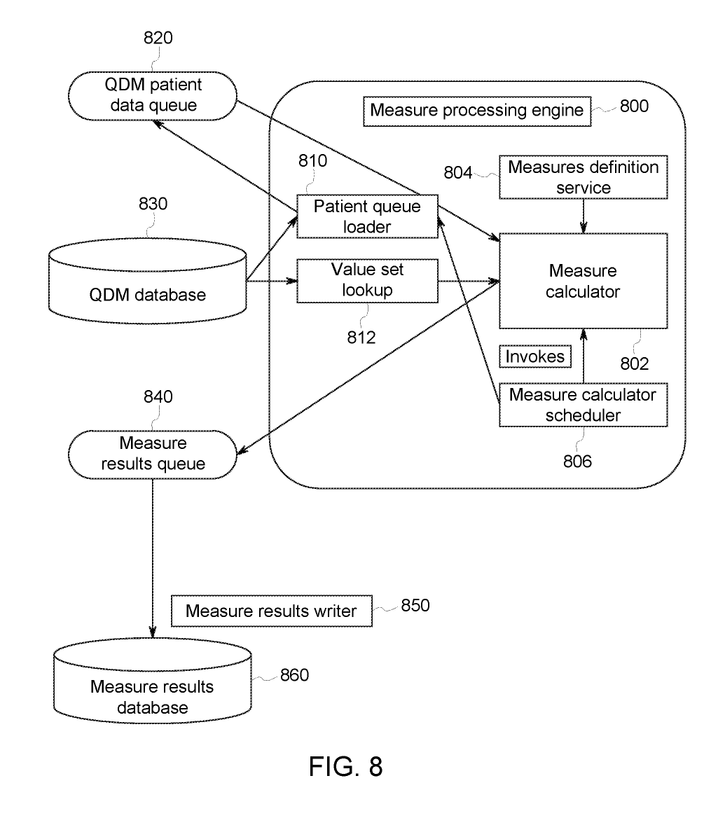

FIG. 8 illustrates an example measure processing engine 800. The example engine includes a measure calculator 802, a measure calculator scheduler 806, a measure definition service 804, a patient queue loader 810, and a value set lookup 812. The measure calculator 802 loads measure definitions resource files from the measure definition service 804 into a rule processing engine (e.g., Drools) and retrieves patient QDM data. The measure definition service 804 parses and validates measure definitions and provides APIs to retrieve measure-specific information.

The measure calculator 802 is invoked by the measure calculator scheduler 806. The measure calculator 802 run is based on a combination of subset of patient data, measurement period, and subset of measures, for example. Provider specific measure calculation can be expressed as using subset of patients relative to this provider, for example.

The measure calculator 802 invokes the patient queue loader 810 to normalize and load patient QDM data into a patient data queue 820. The QDM patient data queue 820 is a memory queue that can be pre-populated from a QDM database 830 so that the measure calculator 802 can use cached information instead of loading data directly from the database 830. The queue 820 is populated by the patient queue loader 810 (producer) and consumed by the measure calculator 802. The loader 810 stops once the queue 820 reaches certain configurable limit, for example. The value set lookup module 812 checks value set parent-child relationship and cache most common value sets combinations, for example.

The measure calculator 802 spans a set of worker threads that consume QDM information from the queue 820. For example, measure calculator threads generate based on measure definition and apply a set of rules to QDM patient data to produce measure results.

The measure calculator 802 performs measure processing and saves results into a measure results database 860. Results can be written to the database 860 from a measure results queue 840 via a measure results writer 850, for example. The measure results queue 840 is responsible for serializing measure computation results. In certain examples, the queue 840 can be persistent and can be implemented as temporary table. The measure results queue 840 allows decoupling results persistence strategy from measure computation.

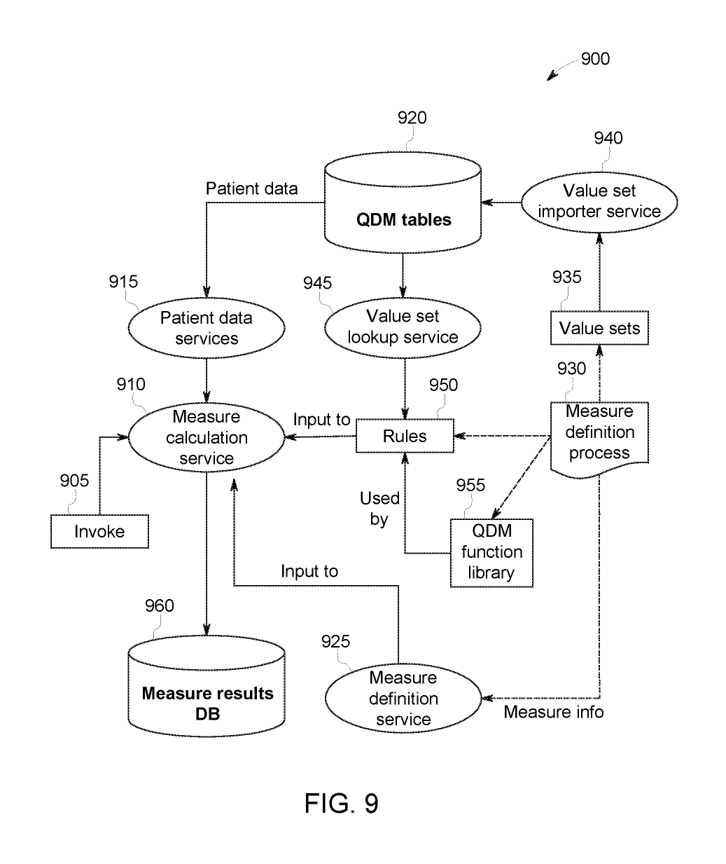

FIG. 9 illustrates a flow diagram of an example method 900 to calculate measures using the example measure calculator. At block 905, a measure calculation service 910 is invoked to calculate an entity's result with respect to a selected measure. A patient data service 915 provides patient data to the measure calculation service 910 based on information from data tables (e.g., QDM data tables). A measure definition service 925 provides measure definition information for the measure calculation service 910.

The measure definition service 925 receives input from a measure definition process 930. The measure definition process 930 also provides one or more value sets 935 to a value set importer service 940. The value set importer service 940 imports values into the QDM tables 920, for example. The QDM tables 920 can provide information to a value set lookup service 945 which is used by a rules engine 950. The measure definition process 930 can also provide information to the rules engine 950 and/or to a QDM function library 955, which in turn is also used by the rules engine 950. The rules engine 950 provides input to the measure calculation service 910.

After calculating the measure, the measure calculation service 910 provides results for the measure to a measure results database 960. Measures can include patient-based measures, episode-of-care measures, etc. Functional measures can include visit-based measures, patient-related measure, event-based measures, etc. In certain examples, patient data can be filtered to be provider-specific and/or may not be provider-specific.

In certain examples, a quality data model (QDM) element is organized according to category, datatype, and attribute. Examples of category include diagnostic study, laboratory test, medication, etc. Examples of datatype include diagnostic study performed, laboratory test ordered, medication administered, etc. Examples of attribute include method of diagnostic study performed, reason for order of laboratory test, dose of medication administered, etc.

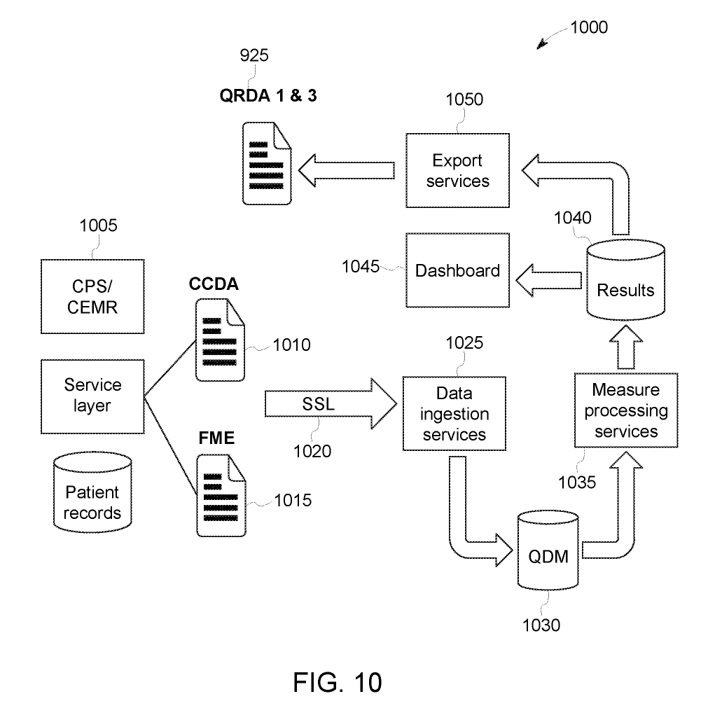

FIG. 10 illustrates a flow diagram for an example method 1000 for clinical quality reporting. As illustrated in the example of FIG. 10, data from one or more sources 1005 (e.g., EMR, service layer, patient records, etc.) is provided in one or more formats 1010 (e.g., consolidated clinical document architecture (CCDA) patient record data triggered by document signing, functional measure events (FME) generated nightly, etc.) to a data ingestion service 1025 via a connection 1020 (e.g., a secure sockets layer (SSL) connection, etc.). The data ingestion service 1025 processes the data into one or more quality data models (QDMs) 1030. The QDM information is then provided to measure processing services 1035, which process the QDM information according to one or more selected measure(s) and provide comparison results 1040. The results 1040 are then visualized via a dashboard 1045 and can also be externalized via export services 1050. A user can review the results via the dashboard 1045, and export services 1050 can generate one or more documents, such as government reporting documents, on demand. For example, export services 1050 can provide reporting document according to a quality reporting document architecture (QRDA) category one, category three, etc.

In certain examples, clinical quality reporting can accept data from any system capable of exporting clinical data via standard HL7 CCDA documents. In certain examples, an ingestion process for CCDA documents enforces use of data coding standards and supports a plurality of CCDA templates, such as medication-problem-encounter-payer templates, allergy-patient demographics-family history-immunization templates, functional status-procedure-medical equipment-plan of care templates, results-vital signs-advanced directive-social history templates, etc.

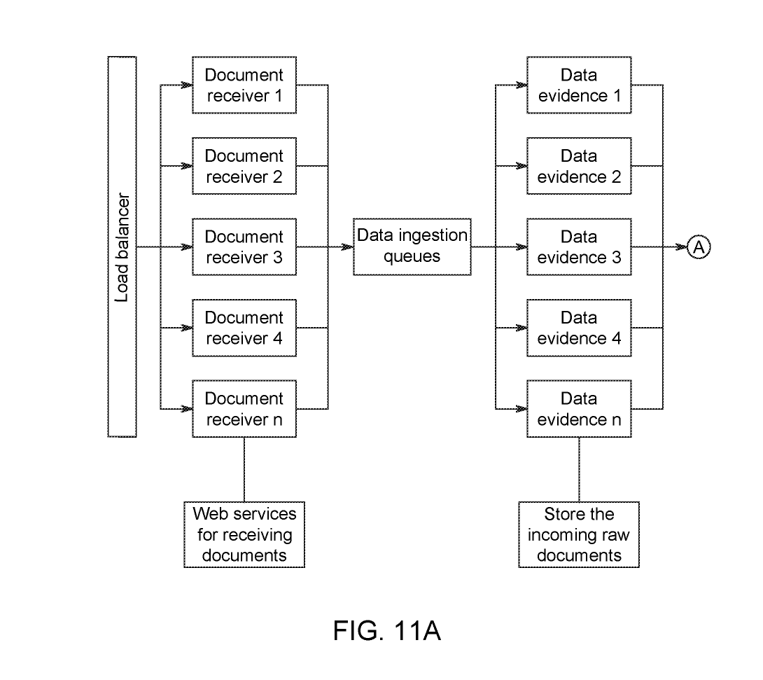

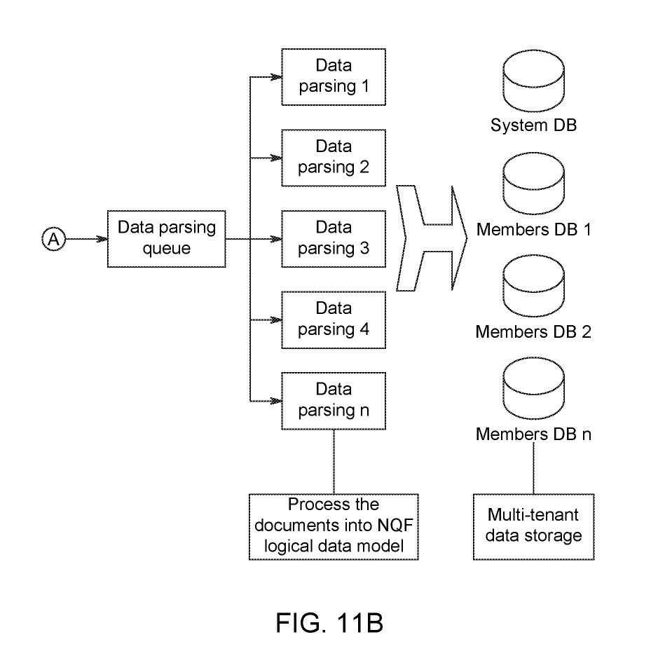

FIG. 11 provides an example of data ingestion services 1100 in a clinical quality reporting system. The example system 1100 includes one or more web services 1110 to receive documents. A load balancer 1105 may be used to balance a load between services and/or originating systems to provide/receive the documents. One or more data ingestion queues 1115 provide the incoming raw documents for storage 1120. A data parsing queue 1125 processes the documents into a logical data model 1130. The modeled data is then stored in multi-tenant storage 1135.

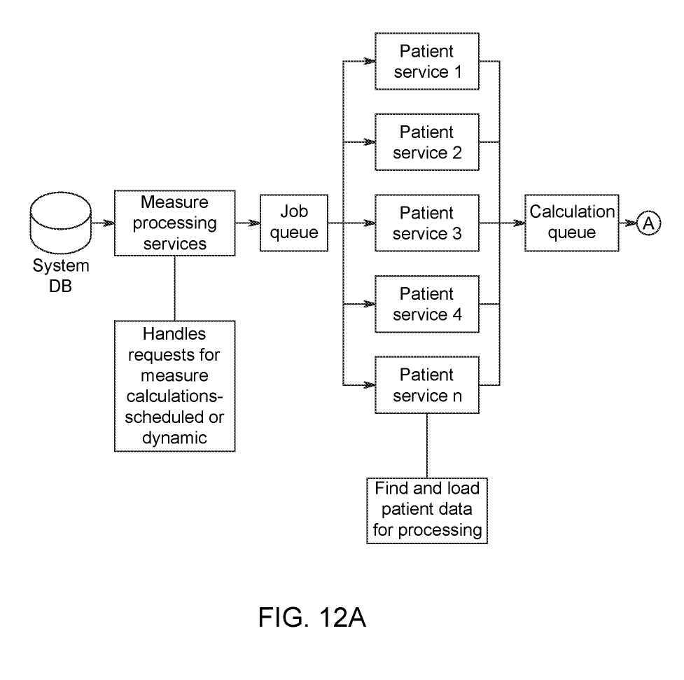

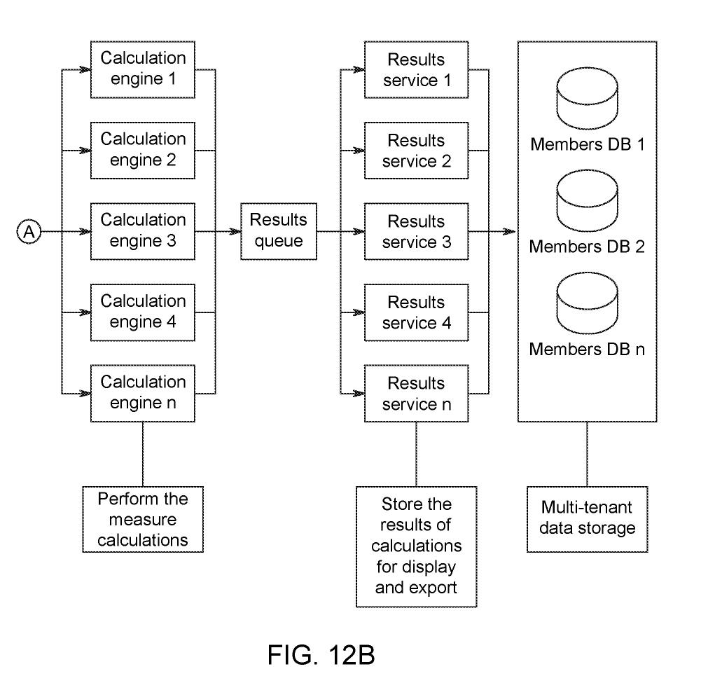

FIG. 12 provides an example of message processing services 1200 in a clinical quality reporting system. Data is loaded from a data store 1205 and provided to measure processing services 1210, which handle requests for measure calculations (e.g., scheduled and/or dynamic (e.g., on-demand), etc.). Measure requests are placed in a job queue 1215 which releases request to find and load patient data for processing via one or more patient services 1220. Patient data is placed into a calculation queue 1225 which provides the data to one or more calculation engines 1230, which perform the measure calculations. Results are placed in a results queue 1235, which routes results to one or more results services 1240 to store the results of the calculations for display and/or export (e.g., in multi-tenant data storage 1245).

Certain examples provide a graphical user interface and associated clinical quality reporting tool. The reporting tool provides a reporting engine designed to meet clinical quality measurement and reporting requirements (e.g., MU, PQRS, etc.) as well as facilitate further analytics and healthcare quality and process improvements. In certain examples, the engine may be a cloud-based tool accessible to users over the Internet, an intranet, etc. In certain examples, user EMRs and/or other data storage send the cloud server a standardized data feed daily (e.g., every night), and reports are generated on-the-fly such that they are up to date as well as HIPAA compliant.

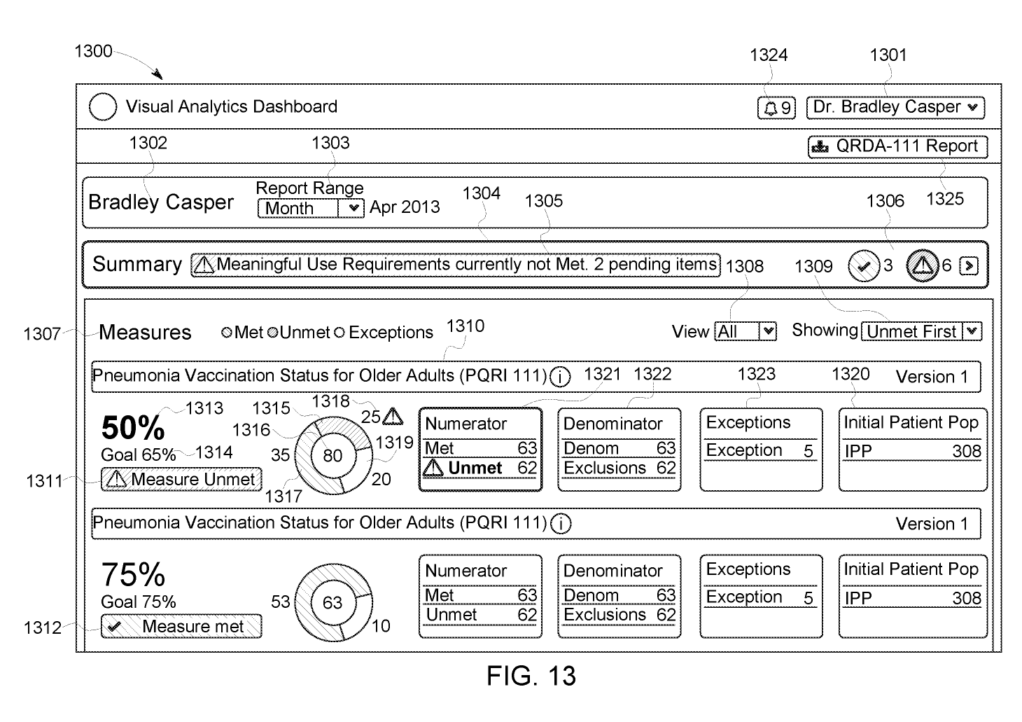

FIG. 13 depicts an example visual analytics dashboard user interface 1300 providing quality reporting and associated analytics to a clinical user. Via the dashboard interface 1300, a user 1301 can be selected. For the selected user 1302, available measure report information is provided. In certain examples, the user can select a date range 1303 for the reports.

A summary section 1304 is provided to immediately highlight to the user his or her performance (or his or her institution's performance, etc.) with respect to the target requirement and associated measure(s) (e.g., meaningful use requirements). As show in the example of FIG. 13, a ribbon 1305 visually indicates in red and with a triangular exclamation icon that meaningful use requirements are currently not met for Dr. Casper. In the example of FIG. 13, two pending items must be resolved. Also within the summary box 1304, additional graphical indicators, such as a green check mark and a red triangular exclamation icon indicate numbers of measures that met or do not meet their targets/guidelines.

Below the summary 1304 in the example of FIG. 13, further detail on the particular measures 1307 is provided. Information can be categorized as met, unmet, or exception, for example. Measure information can be filtered based on type to view 1308 (e.g., all, met, unmet, exception, etc.) and can be ordered 1309 (e.g., show unmet first, show met first, show exceptions first, show in priority order, show in date order, show in magnitude order, etc.).

For each measure 1310, an indication of unmet 1311 or met 1312 is provided. The indication may include text, icons, color, size, etc., to visually convey information, urgency, important, magnitude, etc., to the user. A percentage 1313 is displayed relative to a goal 1314 indicating what percent of the patients meet the measure 1313 versus the goal percentage 1314 in order to meet the measure for the clinician (or practice, or hospital, etc., depending upon hierarchy and/or granularity).

Additionally, as shown in FIG. 13, a ring icon 1315 provides a visual indication of the status of the measure with respect to the target entity (e.g., Dr. Casper here). The ring icon 1315 includes a total number of patients 1316 and/or other data points involved in the measure as well as individual segments corresponding to met 1317, unmet 1318, and exceptions 1319. In some examples, a ring icon 1315 may only include one or more of these segments 1317-1319 as one or more of the segments 1317-1319 may not apply (e.g., the second and third measures shown in FIG. 13 indicate that all patients either meet or are excepted from the second measure and all patients for Dr. Casper meet the third measure shown in the example of FIG. 13). The segments 1317-1319 of the ring icon 1315 may be distinguished by color, shading, size, etc., and may also (as shown in the example of FIG. 13) be associated with an alphanumeric indication of a number of patients associated with the particular segment (e.g., 35 met, 25 unmet, 20 exceptions shown in FIG. 13). An additional icon may highlight or emphasize the number of unmet 1318, for example.

The example interface 1300 may further breakdown for the user information regarding the initial patient population 1320, numerator 1321 for the measure 1310 (including number of met and unmet), denominator 1322 for the measure 1310 (including number of denominator and exclusions), and exceptions 1323. As shown in the example of FIG. 13, a box and/or other indicator may draw attention to a “problem” area, such as the number of unmet in the numerator 1321.

In certain examples, selection of an item on the interface 1300 provides further information regarding that item to the user. Further, the interface 1300 may provide an indication of a number of alerts or items 1324 for user attention. The interface 1300 may also provide the user with an option to download and/or print a resulting report 1325 based on compliance with the measure(s).

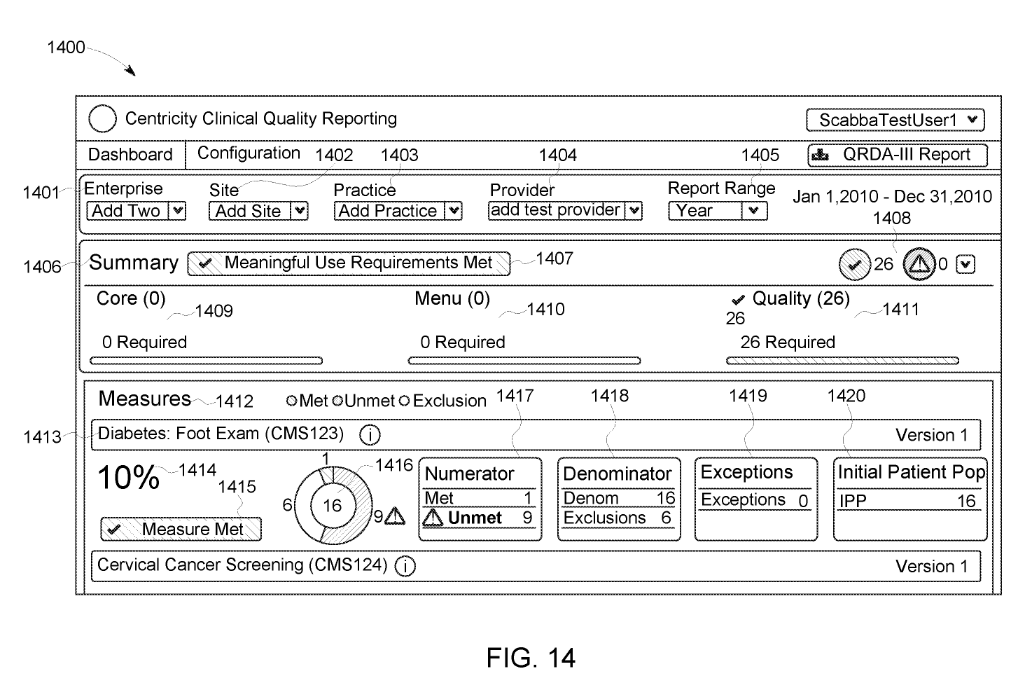

FIG. 14 illustrates another example dashboard interface 1400 providing analytics and quality reporting. As shown in the example of FIG. 14, a user can, via the interface 1400, select and/or otherwise specify one or more of: an enterprise 1401, a site 1402, a practice 1403, a provider 1404, and/or a date range 1405 to provide a desired scope and/or level of granularity for results. These values may be initially configured by an administrator or manager, for example, and then access/specified by a user depending upon his or her level of access/role as defined by the administrator/manager, for example.

Based on the selected parameters 1401-1405, a summary 1406 of one or more relevant measures is provided to the user via the dashboard 1400. The summary 1406 provides an indication of success or failure in a succinct display such as the box or ribbon 1407 depicted in the example. Here, as opposed to the example of FIG. 13, the meaningful use requirements are met, so the box is green and has a check mark icon in it. Additional icons 1408 can provide an indication of numbers of met (here 26) and unmet (here 0) measures in the data set. Further, a user can select to provide additional detail (shown in the example of FIG. 14 but not in the example of FIG. 13) of which measures were met/unmet. In the example, core 1409, menu 1410, and quality 1411 measures are shown, with zero core measures 1409 required, zero menu measures 1410 required, and twenty-six quality measures 1411 required (all met in the example here).

As discussed with respect to the example of FIG. 13, the interface 1400 of FIG. 14 similarly provides particular information in a measures section 1412 regarding one or more particular measures 1413 including a completion percentage 1414, an indication of met/unmet 1415, a ring icon 1416, and further information regarding numerator 1417, denominator 1418, exceptions 1419, and IPP 1420.

Certain examples can drive access to the underlying data and/or patterns of data (e.g., at one or more source systems) to help enable mitigation and/or other correction of failures and/or other troublesome results via the interface 1300, 1400. Certain examples can provide alternatives and/or suggestions for improvement and/or highlight or otherwise emphasize opportunities via the interface 1300, 1400.

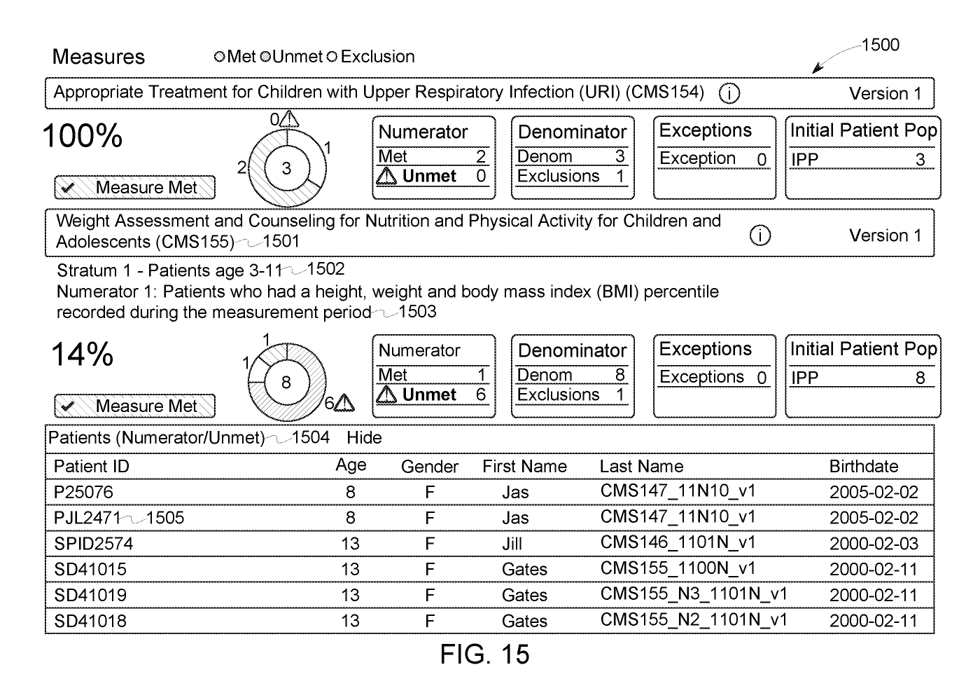

FIG. 15 illustrates another example analytic measures dashboard 1500 in which for a particular measure 1501, additional detail is displayed to the user such as a stratum for the measure (patients age 3-11 in this example), an explanation of the numerator (patients who had a height, weight and body mass index percentile recorded during the measurement period in this example). The example interface 1500 further allows the user to view and/or otherwise select further patient information, such as a number of patients in the numerator that did not meet the measure 1504. For that criterion (e.g., numerator/unmet, etc.), a list of applicable patients 1505 is displayed for user review, selection, etc.

Thus, via the interface(s) 1300, 1400, 1500 a user can see which measures the user passed or failed and can drill in to see what is happening with each particular measure and/or group of measures. Measures can be filtered for enterprise, one or more sites in an enterprise, one or more practices in a site, one or more providers in a practice, etc. In certain examples, a user can select a patient via the interface 1300, 1400, 1500 (e.g., a patient 1505 listed in the example interface of FIG. 15) to link back into an EMR or other clinical system to start making an appointment, send a message, prepare a document, etc. Alternatively, the user can take the patient identifier and go back to his/her system to schedule follow-up, for example.

Certain examples provide an interface for a user to select a set of measures/requirements (e.g., MU, PQRS, etc.) and then select which measures he or she is going to track. For example, a provider can select which MU stage he/she is in, select a year, and then select measure(s) to track. Only those selected measures appear in the dashboard for that provider, for example. When the provider is done reviewing reports, he/she can download the full report and then upload it to CMS as part of a meaningful use attestation, for example. In certain examples, access to information, updates, etc., may be subscription based (and based on permission). In addition to collecting data for quality reports, certain examples de-identify or anonymize the data to use it for clinical analytics as well (e.g., across a population, deeper than quality reporting across a patient population, etc).

Thus, for example, at a healthcare organization, an administrator can decide what measures they want to track (e.g., core measures, menu measures, clinical quality measures, etc.), and they can decide they want to track eleven of the twenty available clinical quality measures rather than only the six or seven that are required). They can check the measures they want in a configuration screen for the application. The organization can track for a particular doctor at a particular facility, for example, to see how he/she is doing for those selected quality measures (e.g., did they send an electronic discharge summary, did they check this indicator for a pregnant woman, etc.). If they did not comply, the unmet will be flagged and the doctor will have to go back into the EMR and follow-up with the patient and re-run the quality measures to update the system so that now the measure passes, where before the measure had failed. Documentation, such as QRDA 1 and 3 documents, can be downloaded and submitted to verify compliance. Performance can be measured by provider, by facility, and/or by organization, etc., for one or more particular measures to provide an aggregate view that can be sliced and diced with varying analytics and data views.

In certain examples, a specification for a requirement or measure can be in a machine-readable format (e.g., XML). Certain examples facilitate automated processing of the specification to build the specification into rules to be used by the analytics system when calculating measurements and determining compliance (e.g., automatically ingesting and parsing CCDA documents to generate rules for measure calculation). In certain examples, measure authoring tools can also allow users to create their own KPIs using this parser.

Certain examples allow a system to intake data in a clinical information model, scrub PHI out of the data, and move the scrubbed, modeled data into de-identified data store for analytics. This data can then be exposed to other uses, for example. De-identified analytics can be performed with several analytic algorithms and an analytic runtime engine to enable a user to create and publish different data models and algorithms into different libraries to more rapidly build analytics around the data and expose the data and analytics to a user (e.g., via one or more analytic visualizations. Techniques such as modeling, machine learning, simulation, predictive algorithms, etc., can be applied to the data analytics, for example, to identify trends, cohorts, etc., that can be hidden in big data. Identified trends, cohorts, etc., can then be fed back into the system to improve the models and analytics, for example. Thus, analytics can improve and/or evolve based on observations made by the system and/or users when processing the data. In certain examples, analytics applications can be built on top of the analytics visualizations to take advantage of correlations and conclusions identified in the analytics results.

Certain examples help a user find answers to “high value questions”, often characterized by one or more of workflow, profitability, satisfaction, complexity, tipping point, etc. A value of the high value question (HVQ) can be based on action and workflow inflection, not data volumes, for example.

A length of stay (LOS) is an example tipping point). Being able to understand for a patient how close the provider is getting to the LOS tipping point from admit to bed to assignment to ward, etc., and to identify where the provider hits the tipping point and how the provider can combat it, etc., can help provide a useful answer or solution to that HVQ for the provider. Such answers are often dynamic, with insight occurring, for example, every hour for every patient, so certain examples provide an analytic that is up and running for every patient and every transaction going through a hospital as part of an overall strategy of approaching a high value question.

When a patient is compared against a measure, they may pass or fail, but the provider wants to know what particular patient data criterion is causing them to fail so that it can be brought to the attention of the business analyst, clinician, etc. Certain examples provide a view into what kind of patient data points are causing them to fail. Certain examples provide analytics to identify and visualize patterns of failure that could inform the clinician as to how they could better address the situation and improve the performance measure. Certain examples provide insight and more analytics around the specific patient data criteria and why the provider failed one or more particular measures.

Health information, also referred to as healthcare information and/or healthcare data, relates to information generated and/or used by a healthcare entity. Health information can be information associated with health of one or more patients, for example. Health information can include protected health information (PHI), as outlined in the Health Insurance Portability and Accountability Act (HIPAA), which is identifiable as associated with a particular patient and is protected from unauthorized disclosure. Health information can be organized as internal information and external information. Internal information includes patient encounter information (e.g., patient-specific data, aggregate data, comparative data, etc.) and general healthcare operations information, etc. External information includes comparative data, expert and/or knowledge-based data, etc. Information can have both a clinical (e.g., diagnosis, treatment, prevention, etc.) and administrative (e.g., scheduling, billing, management, etc.) purpose.

Institutions, such as healthcare institutions, having complex network support environments and sometimes chaotically driven process flows utilize secure handling and safeguarding of the flow of sensitive information (e.g., personal privacy). A need for secure handling and safeguarding of information increases as a demand for flexibility, volume, and speed of exchange of such information grows. For example, healthcare institutions provide enhanced control and safeguarding of the exchange and storage of sensitive patient PHI and employee information between diverse locations to improve hospital operational efficiency in an operational environment typically having a chaotic-driven demand by patients for hospital services. In certain examples, patient identifying information can be masked or even stripped from certain data depending upon where the data is stored and who has access to that data. In some examples, PHI that has been “de-identified” can be re-identified based on a key and/or other encoder/decoder.

A healthcare information technology infrastructure can be adapted to service multiple business interests while providing clinical information and services. Such an infrastructure can include a centralized capability including, for example, a data repository, reporting, discreet data exchange/connectivity, “smart” algorithms, personalization/consumer decision support, etc. This centralized capability provides information and functionality to a plurality of users including medical devices, electronic records, access portals, pay for performance (P4P), chronic disease models, and clinical health information exchange/regional health information organization (HIE/RHIO), and/or enterprise pharmaceutical studies, home health, for example.

Interconnection of multiple data sources helps enable an engagement of all relevant members of a patient's care team and helps improve an administrative and management burden on the patient for managing his or her care. Particularly, interconnecting the patient's electronic medical record and/or other medical data can help improve patient care and management of patient information. Furthermore, patient care compliance is facilitated by providing tools that automatically adapt to the specific and changing health conditions of the patient and provide comprehensive education and compliance tools to drive positive health outcomes.

In certain examples, healthcare information can be distributed among multiple applications using a variety of database and storage technologies and data formats. To provide a common interface and access to data residing across these applications, a connectivity framework (CF) can be provided which leverages common data and service models (CDM and CSM) and service oriented technologies, such as an enterprise service bus (ESB) to provide access to the data.

In certain examples, a variety of user interface frameworks and technologies can be used to build applications for health information systems including, but not limited to, MICROSOFT® ASP.NET, AJAX®, MICROSOFT® Windows Presentation Foundation, GOOGLE® Web Toolkit, MICROSOFT® Silverlight, ADOBE®, and others. Applications can be composed from libraries of information widgets to display multi-content and multi-media information, for example. In addition, the framework enables users to tailor layout of applications and interact with underlying data.

In certain examples, an advanced Service-Oriented Architecture (SOA) with a modern technology stack helps provide robust interoperability, reliability, and performance. The example SOA includes a three-fold interoperability strategy including a central repository (e.g., a central repository built from Health Level Seven (HL7) transactions), services for working in federated environments, and visual integration with third-party applications. Certain examples provide portable content enabling plug 'n play content exchange among healthcare organizations. A standardized vocabulary using common standards (e.g., LOINC, SNOMED CT, RxNorm, FDB, ICD-9, ICD-10, etc.) is used for interoperability, for example. Certain examples provide an intuitive user interface to help minimize end-user training. Certain examples facilitate user-initiated launching of third-party applications directly from a desktop interface to help provide a seamless workflow by sharing user, patient, and/or other contexts. Certain examples provide real-time (or at least substantially real time assuming some system delay) patient data from one or more information technology (IT) systems and facilitate comparison(s) against evidence-based best practices. Certain examples provide one or more dashboards for specific sets of patients. Dashboard(s) can be based on condition, role, and/or other criteria to indicate variation(s) from a desired practice, for example.

Certain examples can be implemented as cloud-based clinical information systems and associated methods of use. An example cloud-based clinical information system enables healthcare entities (e.g., patients, clinicians, sites, groups, communities, and/or other entities) to share information via web-based applications, cloud storage and cloud services. For example, the cloud-based clinical information system may enable a first clinician to securely upload information into the cloud-based clinical information system to allow a second clinician to view and/or download the information via a web application. Thus, for example, the first clinician may upload an x-ray image into the cloud-based clinical information system, and the second clinician may view the x-ray image via a web browser and/or download the x-ray image onto a local information system employed by the second clinician.

In certain examples, users (e.g., a patient and/or care provider) can access functionality provided by the systems and methods via a software-as-a-service (SaaS) implementation over a cloud or other computer network, for example. In certain examples, all or part of the systems can also be provided via platform as a service (PaaS), infrastructure as a service (IaaS), etc. For example, a system can be implemented as a cloud-delivered Mobile Computing Integration Platform as a Service. A set of consumer-facing Web-based, mobile, and/or other applications enable users to interact with the PaaS, for example.

The Internet of things (also referred to as the “Industrial Internet”) relates to an interconnection between a device that can use an Internet connection to talk with other devices on the network. Using the connection, devices can communicate to trigger events/actions (e.g., changing temperature, turning on/off, provide a status, etc.). In certain examples, machines can be merged with “big data” to improve efficiency and operations, provide improved data mining, facilitate better operation, etc.

Big data can refer to a collection of data so large and complex that it becomes difficult to process using traditional data processing tools/methods. Challenges associated with a large data set include data capture, sorting, storage, search, transfer, analysis, and visualization. A trend toward larger data sets is due at least in part to additional information derivable from analysis of a single large set of data, rather than analysis of a plurality of separate, smaller data sets. By analyzing a single large data set, correlations can be found in the data, and data quality can be evaluated.

Thus, device in the system become “intelligent” as a network with advanced sensors, controls, and software applications. Using such an infrastructure, advanced analytics can be provided to associated data. The analytics combines physics-based analytics, predictive algorithms, automation, and deep domain expertise. Via the cloud, devices and associated people can be connected to support more intelligent design, operations, maintenance, and higher server quality and safety, for example.

Using the industrial internet infrastructure, for example, a proprietary machine data stream can be extracted from a device. Machine-based algorithms and data analysis are applied to the extracted data. Data visualization can be remote, centralized, etc. Data is then shared with authorized users, and any gathered and/or gleaned intelligence is fed back into the machines.

Imaging informatics includes determining how to tag and index a large amount of data acquired in diagnostic imaging in a logical, structured, and machine-readable format. By structuring data logically, information can be discovered and utilized by algorithms that represent clinical pathways and decision support systems. Data mining can be used to help ensure patient safety, reduce disparity in treatment, provide clinical decision support, etc. Mining both structured and unstructured data from radiology reports, as well as actual image pixel data, can be used to tag and index both imaging reports and the associated images themselves.

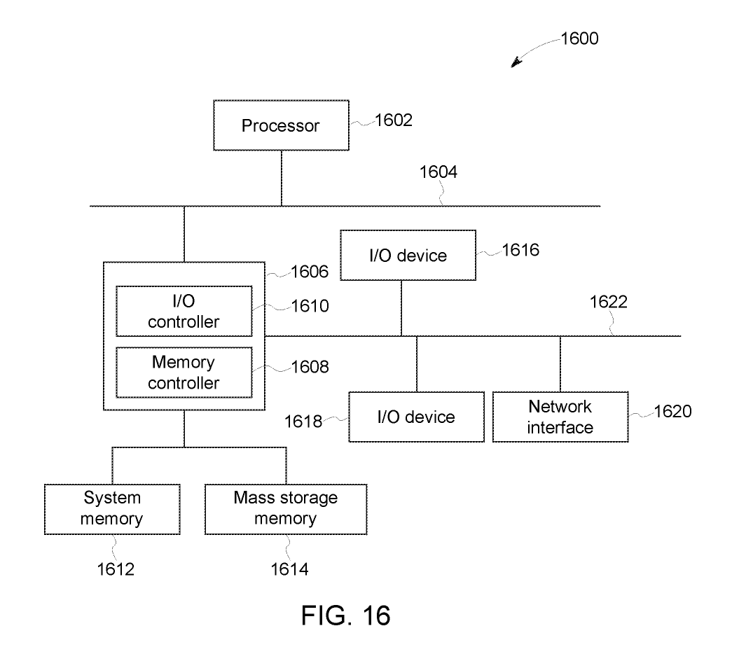

FIG. 16 is a block diagram of an example processor system 1610 that may be used to implement the systems, apparatus and methods described herein. As shown in FIG. 16, the processor system 1610 includes a processor 1612 that is coupled to an interconnection bus 1614. The processor 1612 may be any suitable processor, processing unit or microprocessor. Although not shown in FIG. 16, the system 1610 may be a multi-processor system and, thus, may include one or more additional processors that are identical or similar to the processor 1612 and that are communicatively coupled to the interconnection bus 1614.

The processor 1612 of FIG. 16 is coupled to a chipset 1618, which includes a memory controller 1620 and an input/output (I/O) controller 1622. As is well known, a chipset typically provides I/O and memory management functions as well as a plurality of general purpose and/or special purpose registers, timers, etc. that are accessible or used by one or more processors coupled to the chipset 1618. The memory controller 1620 performs functions that enable the processor 1612 (or processors if there are multiple processors) to access a system memory 1624 and a mass storage memory 1625.

The system memory 1624 may include any desired type of volatile and/or nonvolatile memory such as, for example, static random access memory (SRAM), dynamic random access memory (DRAM), flash memory, read-only memory (ROM), etc. The mass storage memory 1625 may include any desired type of mass storage device including hard disk drives, optical drives, tape storage devices, etc.

The I/O controller 1622 performs functions that enable the processor 1612 to communicate with peripheral input/output (I/O) devices 1626 and 1628 and a network interface 1630 via an I/O bus 1632. The I/O devices 1626 and 1628 may be any desired type of I/O device such as, for example, a keyboard, a video display or monitor, a mouse, etc. The network interface 1630 may be, for example, an Ethernet device, an asynchronous transfer mode (ATM) device, an 802.11 device, a DSL modem, a cable modem, a cellular modem, etc. that enables the processor system 1610 to communicate with another processor system.

While the memory controller 1620 and the I/O controller 1622 are depicted in FIG. 16 as separate blocks within the chipset 1618, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Some of the figures described and disclosed herein depict example flow diagrams representative of processes that can be implemented using, for example, computer readable instructions that can be used to facilitate collection of data, calculation of measures, and presentation for review. The example processes of these figures can be performed using a processor, a controller and/or any other suitable processing device. For example, the example processes can be implemented using coded instructions (e.g., computer readable instructions) stored on a tangible computer readable medium (storage medium) such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes can be implemented using coded instructions (e.g., computer readable instructions) stored on a non-transitory computer readable medium such as a flash memory, a read-only memory (ROM), a random-access memory (RAM), a CD, a DVD, a Blu-ray, a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes can be implemented manually or as any combination(s) of any of the foregoing techniques, for example, any combination of firmware, software, discrete logic and/or hardware. Further, although the example processes are described with reference to the flow diagrams provided herein, other methods of implementing the processes may be employed. For example, the order of execution of the blocks can be changed, and/or some of the blocks described may be changed, eliminated, sub-divided, or combined. Additionally, any or all of the example processes can be performed sequentially and/or in parallel by, for example, separate processing threads, processors, devices, discrete logic, circuits, etc.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, Blu-ray, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN), a wide area network (WAN), a wireless network, a cellular phone network, etc., that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

Technical effects of the subject matter described above can include, but is not limited to, providing systems and methods to answer high value questions and other clinical quality measures and provide interactive visualization to address failures identified with respect to those measures. Moreover, the system and method of this subject matter described herein can be configured to provide an ability to better understand large volumes of data generated by devices across diverse locations, in a manner that allows such data to be more easily exchanged, sorted, analyzed, acted upon, and learned from to achieve more strategic decision-making, more value from technology spend, improved quality and compliance in delivery of services, better customer or business outcomes, and optimization of operational efficiencies in productivity, maintenance and management of assets (e.g., devices and personnel) within complex workflow environments that may involve resource constraints across diverse locations.

This written description uses examples to disclose the subject matter, and to enable one skilled in the art to make and use the invention. The patentable scope of the subject matter is defined by the following claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An apparatus comprising:
a processor configured to execute instructions to implement and display, via a graphical user interface, at least:
a dashboard configured for a key performance indicator, the dashboard to display an evaluation of a plurality of patients analyzed with respect to a key performance indicator including:
a summary of results for the key performance indicator measured with respect to the plurality of patients at a healthcare institution, the summary of results including an aggregated analysis of the plurality of patients with respect to the key performance indicator, the summary of results selectable via the graphical user interface during a patient encounter with a healthcare provider to display a listing of at least a subset of the plurality of patients failing the key performance indicator,
a representation of a first patient in the listing selectable via the graphical user interface to display a visualization regarding the failure of the first patient with respect to the key performance indicator, the representation of the first patient to facilitate interaction with a clinical system to bring the first patient into compliance with the key performance indicator via the clinical system during the patient encounter for the first patient with the healthcare provider.

2. The apparatus of claim 1, wherein the processor is to aggregate data from a plurality of information systems for the first patient to evaluate the first patient with respect to the key performance indicator.

3. The apparatus of claim 1, wherein the processor is to predict compliance or lack of compliance by the first patient with the key performance indicator in real time during the patient encounter.

4. The apparatus of claim 1, wherein the summary of results further includes a visualization of a pattern of failure associated with the key performance indicator.

5. The apparatus of claim 4, wherein the visualization of the pattern of failure is to highlight inherent delay apart from an associated operational metric for the key performance indicator.

6. The apparatus of claim 4, wherein the visualization of the pattern of failure is to identify a trend in analyzed data with respect to the key performance indicator.

7. The apparatus of claim 1, wherein the representation of the first patient is selectable to show requirements to be met to satisfy the key performance indicator for the first patient.

8. A non-transitory computer-readable storage medium including instructions which, when executed, cause the processor to implement and display, via a graphical use interface, at least:
a dashboard configured for a key performance indicator, the dashboard to display an evaluation of a plurality of patients analyzed with respect to a key performance indicator including:
a summary of results for the key performance indicator measured with respect to the plurality of patients at a healthcare institution, the summary of results including an aggregated analysis of the plurality of patients with respect to the key performance indicator, the summary of results selectable via the graphical user interface during a patient encounter with a healthcare provider to display a listing of at least a subset of the plurality of patients failing the key performance indicator,
a representation of a first patient in the listing selectable via the graphical user interface to display a visualization regarding the failure of the first patient with respect to the key performance indicator, the representation of the first patient to facilitate interaction with a clinical system to bring the first patient into compliance with the key performance indicator via the clinical system during the patient encounter for the first patient with the healthcare provider.

9. The computer-readable storage medium of claim 8, wherein the processor is to aggregate data from a plurality of information systems for the first patient to evaluate the first patient with respect to the key performance indicator.

10. The computer-readable storage medium of claim 8, wherein the processor is to predict compliance or lack of compliance by the first patient with the key performance indicator in real time during the patient encounter.

11. The computer-readable storage medium of claim 8, wherein the summary of results further includes a visualization of a pattern of failure associated with the key performance indicator.

12. The computer-readable storage medium of claim 11, wherein the visualization of the pattern of failure is to highlight inherent delay apart from an associated operational metric for the key performance indicator.

13. The computer-readable storage medium of claim 11, wherein the visualization of the pattern of failure is to identify a trend in analyzed data with respect to the key performance indicator.

14. The computer-readable storage medium of claim 8, wherein the representation of the first patient is selectable to show requirements to be met to satisfy the key performance indicator for the first patient.

15. A computer-implemented method comprising:
displaying, using a processor via a graphical user interface, a dashboard configured for a key performance indicator, the dashboard to display an evaluation of a plurality of patients analyzed with respect to a key performance indicator including a summary of results for the key performance indicator measured with respect to the plurality of patients at a healthcare institution, the summary of results including an aggregated analysis of the plurality of patients with respect to the key performance indicator;
displaying, in response to a selection of the summary of results via the graphical user interface during a patient encounter with a healthcare provider, a listing of at least a subset of the plurality of patients failing the key performance indicator;
displaying, in response to a selection of a representation of a first patient in the listing via the graphical user interface, a visualization regarding the failure of the first patient with respect to the key performance indicator; and
facilitating interaction, via the representation of the first patient, with a clinical system to bring the first patient into compliance with the key performance indicator via the clinical system during the patient encounter for the first patient with the healthcare provider.

16. The method of claim 15, further including aggregating data from a plurality of information systems for the first patient to evaluate the first patient with respect to the key performance indicator.

17. The method of claim 15, further including predicting compliance or lack of compliance by the first patient with the key performance indicator in real time during the patient encounter.

18. The method of claim 15, further including displaying a visualization of a pattern of failure associated with the key performance indicator in the summary of results.

19. The method of claim 18, wherein the visualization of the pattern of failure is to highlight inherent delay apart from an associated operational metric for the key performance indicator.

20. The method of claim 18, wherein the visualization of the pattern of failure is to identify a trend in analyzed data with respect to the key performance indicator.
